(19) United States
(12) Patent Application Publication
(10) Pub. No.: US 2012/0280496 A1
(43) Pub. Date: Nov. 8, 2012

(54) JOINT WITH HEAT-SHIELDING ELEMENT

(75) Inventors: Moshe Ben-Reuven, Princeton, NJ (US); Bruno E. Araujo, Brooklyn, NY (US)

(73) Assignee: Primus Green Energy Inc., Hillsborough, NJ (US)

(21) Appl. No.: 13/102,370

(22) Filed: May 6, 2011

(51) Int. Cl. F16L 23/00

(52) U.S. Cl. 285/368

(57) ABSTRACT

A joint for connecting pipe sections is provided in which a portion of the joint includes a first pipe section, a first reducer fitting section, a first flange attached to the first pipe section and having holes for receiving fasteners, and a fluid conduit (such as a pipe sleeve) positioned inside at least a portion of the first pipe section and the first reducer fitting, wherein the fluid conduit forms an annular space defined by the outside surface of the fluid conduit wall and the inner walls of the first pipe section and the first reducer fitting. The annular space separates the heat-sensitive flange, a flange gasket, and the flange fasteners from high-temperature fluids flowing in the fluid conduit, thereby allowing for the use of lower rated and less expensive components than would otherwise be required in a direct heat contacting arrangement.

### BACKGROUND OF THE INVENTION

1. Field of the Invention

The present invention relates to welded flange-type connectors used to join pipe sections, and to heat-dissipating or heat-shielding devices for reducing heat-related problems at such joints.

2. Description of the Related Art

Butt welded, bolted, flange-type connectors have traditionally been used to join pipe sections. U.S. Pat. No. 5,163,715, for example, discloses a traditional face flange at a connecting end of a pipe section for joining with another flange at the end of a joining pipe section in an abutting manner. A face gasket is positioned between the flange faces prior to fastening the flanges to each other using bolts to form a seal between the interior surfaces of the flanges. The patent also discloses a polymer concrete liner interior of the pipe sections suitable for withstanding the effects of a geothermal fluid passing through the joint.

U.S. Pat. No. 3,002,871 discloses a butt joint for joining pipe sections in which the ends of the pipes are flared outward at the ends thereby forming a larger annular space where the ends join compared to the size of the sections prior to the flared end portions. Within the additional space provided by the flared ends, a cylindrically-shaped sleeve is positioned inside the joint having an inside diameter approximately the same as the diameter of the main portion of the pipes. The outside surface of the sleeve contacts the interior surface of the flared pipe ends, thus filling the void created by the flared portion. The sleeve runs the length of the joint, and is thus used to provide a tight, pressure-resistant weld.

Certain modern unit operations require transport of high-temperature fluids through pipelines and inlet/outlet devices under very high pressures. In some operations, temperatures higher than 600 degrees Celsius may be observed, and may reach as high as 1200 degrees Celsius. Joining pipe sections or reactor inlets and outlets under those conditions is usually accomplished with flanges and gaskets, but since portions of those joints and gaskets are exposed to the high-temperature, high-pressure gases and fluids flowing past them, they are susceptible to problems, many of which are caused directly or indirectly by forced convective heat transfer from the fluid to the flanges, gaskets, and fasteners. Gasket material, for example, can ablate as high temperature gases flow across or near the surface of the gasket material under those conditions. Moreover, fasteners can become loose due to the elongation of the fastener material when exposed to sustained high temperatures. Those conditions can cause the connection at the joint to fail. And, because it can be prohibitively expensive and time consuming to maintain such devices operating under those conditions, it is desirable to eliminate or minimize those heat-related problems. Additionally, high temperature environments increase the rating requirement for flanges, which increases the capital cost for the entire joint. But even using the highest rated devices for a particular application, the problem of sealing the devices remains problematic.

A typical solution to the above-problems, when encountered, is to fabricate a specialty fastener or gasket, but such custom devices often just address problems that are identified. One-off or custom solutions are expensive and may not satisfy all of the unique requirements for the operation if the user fails to identify all of the causes of the problems.

What is needed, therefore, is a non-permanent pipe-connecting device, which includes a conduit, flanges, gaskets, and fasteners, that addresses the joint problems known to exist with previous pipe-connecting flanges, but does not interfere with the flow of fluids by causing a pressure drop or introduce new problems. Preferably, the device should allow for lower-rated devices than would normally not be suitable for the conditions, to keep capital and maintenance costs down.

### BRIEF SUMMARY OF THE INVENTION

In accordance with the present invention, a joint for a pipe (or conduit) is provided that solves many of the problems associated with joints (e.g., flanges, gaskets, and fasteners) used for high-temperature, high-pressure gas and fluid transport in unit operations, including those using superheated steam.

In particular, a larger diameter (i.e., the next larger standard diameter) flange is used than is require for a particular pipe section, along with reducers at both ends to merge with the original pipe size. The upstream part has a relatively thin inner sleeve or liner for conducting fluid, having the same inner diameter as the pipe sections, and is welded to form an extension of the upstream pipe. (Note: the terms “fluid conduit,” “sleeve,” and “liner” and the like are used interchangeably). The fluid conduit traverses the length of the oversized joint to a point that nearly contacts the downstream pipe, leaving a slight gap between the end of the conduit and the pipe section, thereby forming a radial gap at that part of the joint. This provides for an insulating space between that fluid conduit and the walls of the flared fittings that connect to the flanges. The fluid conduit then separates the fluid flowing within the conduit from the flanges, gasket, and fasteners, thereby impeding the radial heat transfer in the direction of the flanges, gasket, and fasteners.

The invention also includes a pipe or tube that attaches to the discharging end of the connection, extending into a flared connection (a modified reducing fitting) that is mated to a flange. That flange mates with a receiving flange, which in turn is connected to another flared connection (a reducing pipe fitting) connected to the receiving end. The centrally extending fluid conduit, which is attached to the discharging end, passes through the center of the device, as described above, leaving the small gap between it and the receiving end.

In operation, the flow of hot gases or fluids heats the walls of the fluid conduit by forced convection, but because of the gap between the fluid conduit and the flanges, it partially insulates the joint that is external to the conduit. Moreover, the added surface area of the flared connection and larger components provides greater surface exposure to surrounding outside air, which facilitates convective heat transfer to the bulk air near the flange.

This arrangement thus described protects the joint flange, gasket, and fasteners from the intense heat of the gases or fluids flowing through the pipes and fluid conduit. The flange and gasket temperatures are appreciably lower than the internal fluid conduit wall temperature under nominal operating conditions as a result of the use of the present invention.

In accordance with another embodiment of the present invention, a reducing passage/conduit is installed internally, separating a very hot steam flow from the flanged connection to minimize the exposure of the flange, gasket, and fasteners to the direct heat from the flowing gases and fluids in the conduit.

The invention not only solves many of the technological problems observed in connections as discussed above, but it is also economically cost-effective. For example, the direct capital cost of using a one standard size larger flange with sleeve and reducers is generally lower than using an incrementally higher-rated regular-size flange that is rated for the higher heat and pressure of the gases and fluids in the connected pipe sections. Generally, the marginal increase in capital cost for the larger/additional flanged components and/or reducers used according to the present invention is at least comparable to the cost required for high temperature-resistant fasteners and gaskets that would otherwise be required without the present invention. Further cost savings are observed by the elimination of additional maintenance required in continuous high-temperature operations, such as the required re-tensioning of fasteners (which may also simply be impossible or prohibitively difficult to do in certain applications).

Inherent in the design of the present invention, the fluid conduit protrudes into the receiving end of the flanged connection; thus it is possible to disassemble the connection by separating the components axially, using, for example, the proper pipe fittings up or downstream to allow for axial separation.

It is, therefore, a principle object of the present invention to provide a joint for connecting pipe sections in a manner that reduces the heat transfer from the gases or fluids flowing in the pipes to the flange components. That object, and other advantages of the present invention, are embodied, as fully described in more detail herein, by a first pipe section having an inside diameter; a first reducer fitting having first and second ends, the first end having an inside diameter substantially the same as the inside diameter of the first pipe section and the second end having an inside diameter smaller than the diameter of the first end, and wherein the first end is connected to an end of the first pipe section; a first flange attached to the first pipe section and having means for connecting the first flange to a second flange; and a fluid conduit positioned inside at least a portion of the first pipe section and the first reducer fitting, wherein the fluid conduit forms an annular space defined by the outside surface of the fluid conduit wall and the inner walls of the first pipe section and the first reducer fitting.

The joint also includes a second pipe section abutting the first pipe section having an inside diameter substantially the same as the inside diameter of the first pipe section. It also includes a second reducer fitting having first and second ends, the first end having an inside diameter substantially the same as the inside diameter of the second pipe section and the second end having an inside diameter smaller than the diameter of the first end, and wherein the first end is connected to an end of the second pipe section. The joint further includes a second flange attached to the second pipe section having means for connecting the second flange to the first flange, and a plurality of fasteners for connecting the first and second flanges in an abutting manner. The joint further includes a gasket adapted to being placed on an end of the first flange. Insulating material may be positioned inside the annular space. In one embodiment, the first end of the fluid conduit extends beyond the second end of the first reducer fitting, and a second end of the fluid conduit extends toward but does not contact the inner surface of the second reducer fitting thereby forming an annular gap between the outer end of the fluid conduit and the inner surface of the second reducer fitting. The fluid conduit expands in at least a longitudinal direction when heat from a transporting fluid inside the fluid conduit is conducted into the fluid conduit, thereby filling the gap.

### BRIEF DESCRIPTION OF THE DRAWINGS

Those and other object, advantages, and features of the invention, as well as the invention itself, will become more readily apparent from the following detailed description when read together with the following drawings, in which:

FIG. 1 is a perspective view diagram of a heat-shielded joint for connecting pipe sections according to one embodiment of the present invention, shown attached to a discharge assembly;

FIG. 2 is a diagram showing a cross-sectional elevation view of the apparatus of FIG. 1 taken along cross-sectional line A-A;

FIG. 3 is a diagram showing a bottom plan view of the apparatus of FIG. 1;

FIG. 4 is a perspective view diagram of the heat-shielded pipe joint according to the one embodiment of the present invention;

FIG. 5 is a schematic diagram showing an elevation view of the pipe joint of FIG. 4;

FIG. 6 is a schematic diagram showing another elevation view of the pipe joint of FIG. 4;

FIG. 7 is a cross-sectional view diagram of the pipe joint taken along cross-sectional line B-B; and

FIG. 8 is a diagram showing a partial cross-sectional elevation view of the heat-shielded joint and a discharge assembly according to a second embodiment of the present invention.

### DETAILED DESCRIPTION OF THE INVENTION

Several preferred embodiments of the present invention are described for illustrative purposes, it being understood that the invention may be embodied in other forms not specifically shown in the drawings. The figures will be described with respect to the structure and functions that achieve one or more of the objects of the invention and/or receive the benefits derived from the advantages of the invention as understood by persons skilled in the art or explicitly set forth herein.

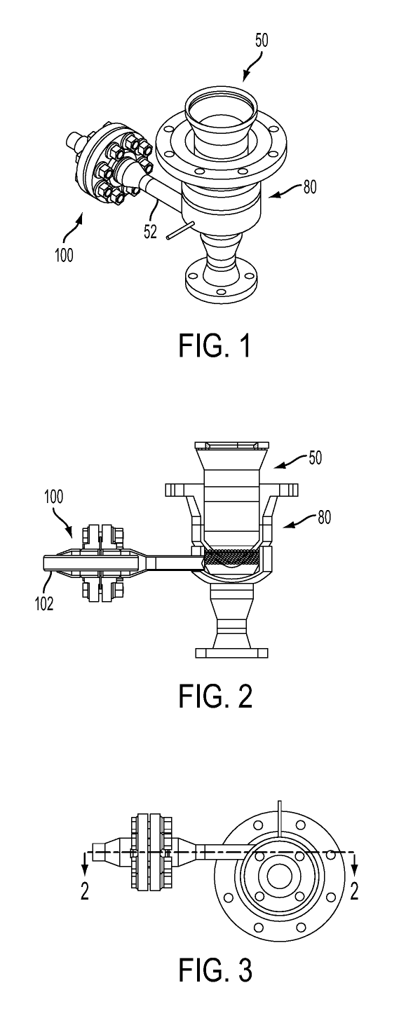

Turning first to FIG. 1, shown therein is perspective view diagram of a heat-shielded pipe joint 100 according to the present invention, for connecting pipe sections, and is shown attached to a discharge assembly 50. For purposes of this description, the discharge assembly 50 essentially describes an apparatus inside a flange section 80. Also for purpose of this description, the pipe joint 100 (hereinafter “joint”) essentially describes an apparatus that includes a butt joint between the ends of two pipes, thereby forming a continuous conduit from one pipe to the other for use in transporting a gas or fluid. The terms “heat-shielded” merely describe one of the functions of some of the components of the joint, and in this case refer to shielding or dissipating thermal energy that would transfer from the gas/fluid to the components of the joint primarily by convection.

The pipe joint 100 is connected to the discharge assembly 50 at a pipe 52, which could be a five-inch, Schedule 40 pipe, but other types and sizes of pipes could also be used.

Turning now to FIG. 2, shown therein is a cross-sectional elevation view of the pipe joint 100 and the discharge assembly 50, taken along cross-sectional line A-A (as best seen in FIG. 3). Within the pipe joint 100 is a fluid conduit 102, which will be described in more detail below. FIG. 3 is a diagram showing a bottom plan view of the pipe joint 100 and the discharge assembly 50.

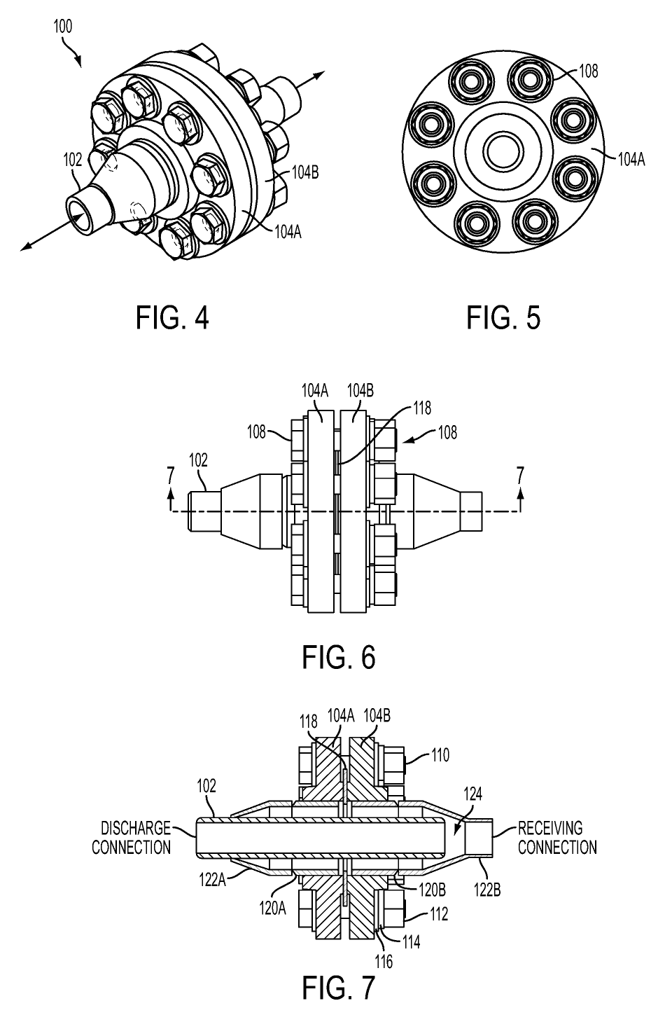

Turning now to FIG. 4, shown therein is a perspective view diagram of the pipe joint 100 according to the present invention, in which an end portion of the fluid conduit 102 is shown extending outward as a receiving or discharge end of the device (the direction of the gas/fluid flow into the pipe joint 100 during operation is indicated by the arrows, but the flow could also be processed in the opposite direction than that shown). The pipe joint 100 includes two slip-on welding flanges 104A, 104B, for connecting respective ends of pipe sections together. FIG. 5, which is a schematic diagram showing an elevation view of the pipe joint 100, shows the flange 104A and eight circumferentially-arranged and spaced-apart fasteners 108 inserted through respective bolt openings (not shown) on the flange 104A. FIG. 6 is a schematic diagram showing another elevation view of the pipe joint 100, further indicating the relationship among each of the components mentioned above.

Turning now to FIG. 7, shown therein is a cross-sectional view diagram of the pipe joint 100 taken along cross-sectional line B-B (the line as shown in FIG. 6). As indicated above, and as described further below, the pipe joint 100 includes the fluid conduit 102, the welding flange 104A, the welding flange 104B, the fasteners 108, a gasket 118, a pipe section 120A, a reducer fitting 122A, another pipe section 120B, and another reducer fitting 122B. An interior space 124 is defined by the outer wall surface of the fluid conduit 102 and the inner wall surfaces of the pipe sections 120A, 120B and the reducer fittings 122A, 122B.

The fluid conduit 102 may be a stainless steel pipe (such as ANSI/ASME B36.19M, Pipe 1, Schedule 40S—8). The welding flanges 104A, 104B may be welding pipe flanges (such as ASME B16.5 slip-on welding, class 300, pipe flanges). The reducer fittings 122A, 122B may be butt welding fittings (such as ASME B16.9 Reducer 2, Schedule 40, wrought butt welding fittings).

The pipe sections 120A, 120B may be stainless steel pipe sections (such as ANSI/ASME B36.19M, Pipe 2, Schedule 40S—1.5). It will be appreciated by one of ordinary skill that the pipe section 120A and reducer fitting 122A could be one integral piece (and likewise, the pipe section 120B and reducer fitting 122B could be one integral piece). They are labeled and described as if they are two different elements for purposes of clarity.

Each of the fasteners 108 includes a hex bolt 110 (such as heavy duty, ANSI B18.2.1, ⅝-11 UNC 3), a hex nut 112 (such as ANSI B18.2.2, ¾-10), a helical spring lock washer 114 (such as a helical spring lock washer, ANSI B18.21.1, 0.75), and a plain washer 116 (such as Type A and B plain washer, ANSI B18.22.1, ¾-inch narrow). One of ordinary skill in the art will appreciate that other fasteners, combinations of fasteners, and arrangement of fasteners could be used, depending on the specific application requirements.

The gasket 118 is preferably a ring joint, spiral wound gasket or metallic gasket for pipe flanges, and could be jacketed. The gasket 118 may be an ASME B16.20 spiral wound metallic gasket for pipe flanges.

The welding flanges 104A, 104B are class 300 slip-on (removable before welding) flanges, each with, in the embodiment shown, eight circumferentially-arranged and spaced apart holes (not shown) for accepting bolt shafts. The pipe sections 120A, 120B are, in the embodiment shown, Schedule 40S, stainless steel pipes.

As shown in FIG. 7, the length of the entire embodiment of the invention thus depicted is 10.5 inches. The end of the fluid conduit 102 that extends outward beyond the end of the reducer fitting 122A does so by 1.09 inches in the embodiment shown. The lengths of the reducer fittings 122A, 122B are each 2.0 inches. The lengths of the pipe sections 120A, 120B are each 4.0 inches. Again, these numerical values are illustrative for the embodiment shown and may vary depending on the application of the invention to which it is employed in a particular operation.

The other end of the fluid conduit 102 is inside the reducer fitting 122B such that the clearance between the outer wall of the end of the fluid conduit 102 and the inner wall of the reducing section of the reducer fitting 122B is, in this embodiment, 0.13 inch. That gap accommodates the thermal expansion (elongation) of the fluid conduit 102 during normal operations, which is generally in the longitudinal direction.

During use, the interior space 124 may be left empty, or it may be filled prior to use with an insulating material suitable for the environment.

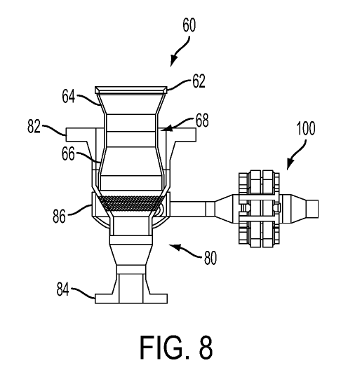

Turning now to FIG. 8, shown therein is a diagram showing a partial cross-sectional elevation view of the joint 100 and a discharge assembly 60 according to a second embodiment of the present invention. The discharge assembly 60 is shown inside the flange section 80. The distance separating the flange 118 and the centerline of the discharge assembly 60 may be, for example, 11 inches.

The flange section 80 includes a flange welding neck 82, which may have a diameter of, for example, 11 inches, a flange welding neck 84, which may have a diameter of, for example, 6 inches, and butt-weld fitting 86. The distance separating the two flange necks 84, 86 may be, for example, about 13 inches. One skilled in the art will appreciate that the flange welding neck 82 is attachable to another flange welding neck (not shown) using fasteners (not shown), separated by a gasket (also not shown) between the two flange parts. In this way, the discharge assembly 60 would be interior of the flange joint held together by the two flange necks.

The discharge assembly 60 includes an ash-diverting ring 62, a lower reducing heat-shielding conduit 64, and an upper reducing heat-shielding conduit 66. As in the case of the reducer fittings 122A, 122B of the joint 100 as described previously, the discharge assembly 60 provides a gap 68 between the fluid being transported inside the discharge assembly 60 and the flange section 80 (and its related components) due to the reduced diameter section of the conduits 64, 66. This shields or dissipates thermal energy that would transfer from the gas/fluid inside the discharge assembly 60 to the components of the joint primarily by convection. The discharge assembly thus installed internally to the flange section 80 may be used, for example, as a fluid conduit like fluid conduit 102 to separate a very hot steam flow from the flanged connection to minimize exposure of the flanges, gasket, and fasteners to direct heat.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

We claim:

1. A joint for connecting pipe sections comprising:
a first pipe section having an inside diameter;
a first reducer fitting section having first and second ends, the first end having an inside diameter substantially the same as the inside diameter of the first pipe section and the second end having an inside diameter smaller than the diameter of the first end, and wherein the first end is connected to an end of the first pipe section;
a first flange attached to the first pipe section and having means for connecting the first flange to a second flange; and
a fluid conduit positioned inside at least a portion of the first pipe section and the first reducer fitting section, wherein the fluid conduit forms an annular space defined by the outside surface of the fluid conduit wall and the inner walls of the first pipe section and the first reducer fitting section.

2. The joint according to claim 1, further comprising a second pipe section proximately abutting the other end of the first pipe section and having an inside diameter substantially the same as the inside diameter of the first pipe section.

3. The joint according to claim 2, further comprising a second reducer fitting section having first and second ends, the first end having an inside diameter substantially the same as the inside diameter of the second pipe section and the second end having an inside diameter smaller than the diameter of the first end, and wherein the first end is connected to an end of the second pipe section.

4. The joint according to claim 2, further comprising a second flange attached to the second pipe section having means for connecting the second flange to the first flange.

5. The joint according to claim 1, further comprising a plurality of fasteners for connecting the first and second flanges in an abutting manner.

6. The joint according to claim 1, further comprising a gasket adapted to being placed on an end of the first flange.

7. The joint according to claim 1, further comprising an insulating material positioned inside the annular space.

8. The joint according to claim 1, wherein a first end of the fluid conduit extends beyond the second end of the first reducer fitting section.

9. The joint according to claim 3, wherein a first end of the fluid conduit extends toward but does not contact the inner surface of the second reducer fitting section, thereby forming an annular gap between the outer end of the fluid conduit and the inner surface of the second reducer fitting section.

10. The joint according to claim 9, wherein the fluid conduit expands in at least a longitudinal direction when heat from a transporting fluid inside the fluid conduit is transferred into the walls of the fluid conduit.

11. The joint according to claim 1, wherein the first pipe section and the first reducer fitting section are an integral piece.

12. A joint for connecting high temperature steam pipe sections comprising:
a first pipe section having an inside diameter;
a second pipe section abutting the first pipe section having an inside diameter substantially the same as the inside diameter of the first pipe section;
a first reducer fitting section having first and second ends, the first end having an inside diameter substantially the same as the inside diameter of the first pipe section and the second end having an inside diameter smaller than the diameter of the first end, and wherein the first end is connected to an end of the first pipe section;
a second reducer fitting section having first and second ends, the first end having an inside diameter substantially the same as the inside diameter of the second pipe section and the second end having an inside diameter smaller than the diameter of the first end, and wherein the first end is connected to an end of the second pipe section;
a first flange attached to the first pipe section having means for connecting to a second flange attached to the second pipe section; and
a fluid conduit positioned inside at least a portion of the first and second pipe sections and the first and second reducer fitting sections, wherein the fluid conduit forms an annular space defined by the outside surface of the fluid conduit wall and the inner walls of the first and second pipe sections and a portion of the first and second reducer fitting sections.

13. The joint according to claim 12, further comprising a plurality of fasteners for connecting the first and second flanges in an abutting manner.

14. The joint according to claim 12, further comprising a gasket adapted to being placed between the first and second flanges.

15. The joint according to claim 12, further comprising an insulating material positioned inside at least a portion of the annular space.

16. The joint according to claim 12, wherein a first end of the fluid conduit extends beyond the second end of the first reducer fitting section.

17. The joint according to claim 13, wherein a second end of the fluid conduit extends toward but does not contact the inner surface of the second reducer fitting section thereby forming an annular gap between the outer second end of the fluid conduit and the inner surface of the second reducer fitting section.

18. The joint according to claim 12, wherein the fluid conduit expands in at least a longitudinal direction when heat from a transporting fluid inside the fluid conduit is transferred to the walls of the fluid conduit.

19. The joint according to claim 12, wherein the first pipe section and the first reducer fitting section are an integral piece.

20. A joint for connecting pipe sections comprising:
a fluid conduit comprising an upper reducing conduit portion and a lower reducing conduit portion; and
a first flange portion having a welding neck adapted to attaching to a welding neck of a second mating flange portion;
wherein the fluid conduit is positioned inside at least a portion of the first flange portion, and wherein the fluid conduit forms an annular space defined by the outside surface of the upper and lower reducing conduit portions and the inner walls of the first flange portion.

21. The joint according to claim 20, further comprising an insulating material positioned inside at least a portion of the annular space.

22. The joint according to claim 20, wherein the upper and lower reducing portions are integral to each other.
